(19) United States
(12) Patent Application Publication
(10) Pub. No.: US 2012/0247633 A1
(43) Pub. Date: Oct. 4, 2012

(54) ANTISKID COVER FOR TIRES

(75) Inventor: Antonio Masi, Firenze (IT)

(73) Assignee: C.A. MASI di Antonio Masi & C. S.a.s., Campi Bisenzio (FI) (IT)

(21) Appl. No.: 13/509,972

(22) PCT Filed: Oct. 13, 2010
(86) PCT No.: PCT/IB10/54627

§ 371 Date: Jun. 19, 2012

(30) Foreign Application Priority Data
Nov. 24, 2009 (IT) FI2009A000245

(51) Int. Cl. B60C 27/06

(52) U.S. Cl. 152/213 R

(57) ABSTRACT

Antiskid cover (1) for tires comprising a ring-shaped band (2) exhibiting an internal surface (5) of contact with the tire (P), an external surface (6) from which an antiskid tread (3) is made to protrude, and two lateral portions (7) defining two circular ring-shaped crowns intended to cover, at least partially, the sides of tire (P). The cover (1) further comprises a device (8) for fixing the cover (1) to the tire and applied to at least a lateral portion (7). Each side portion (7) comprises at least one stiffening element (9) opposite to the fixing element (8).

### TECHNICAL FIELD

The object of the present invention is an antiskid cover fro tires which is to be fitted onto the wheel of the vehicle in order to improve the grip thereof under adverse weather conditions, such as in the presence of snow or ice.

### BACKGROUND ART

At present, besides the traditional snow chains, also known are covers made of fabric, so called snow hoses, which are fixed to the wheels of the vehicle by elastic-retention assembly systems.

Such solutions exhibit however the drawback of a relative rapid wear, especially when used in the absence of snow layer.

As an alternative, snow covers are known having a substratum of fabric and being coated with vulcanized rubber. This cover is less subjected to wear phenomena.

Both these solutions, however, exhibit the drawback of a poor stability and tightness on the wheel, with the consequence that the cover tends to deform and to come out from the wheel during the vehicle run.

### DISCLOSURE OF THE INVENTION

In this context, the technical task of the present invention is to propose an antiskid cover for tires which is able to overcome the above mentioned drawback of the prior art.

In particular, one object of the present invention is to provide an antiskid cover for tires which can ensure a perfect central tightness on the wheel.

A further object of the present invention is to provide an antiskid cover for tires which is of universal application, easily adaptable to different types of wheels and being readily and safely assembled.

The indicated task and specified objects are substantially achieved by an antiskid cover for tires comprising the technical characteristics set forth in one or more of the appended claims.

### BRIEF DESCRIPTION OF THE DRAWINGS

Further characteristics and advantages of the present invention will appear more evident from the indicative, and thus non-limiting, description of a preferred but non-exclusive embodiment of an antiskid cover for tires, as illustrated in the accompanying drawings, wherein:

FIG. 1 is a perspective view of an antiskid cover, according to the present invention, fitted onto a tire;

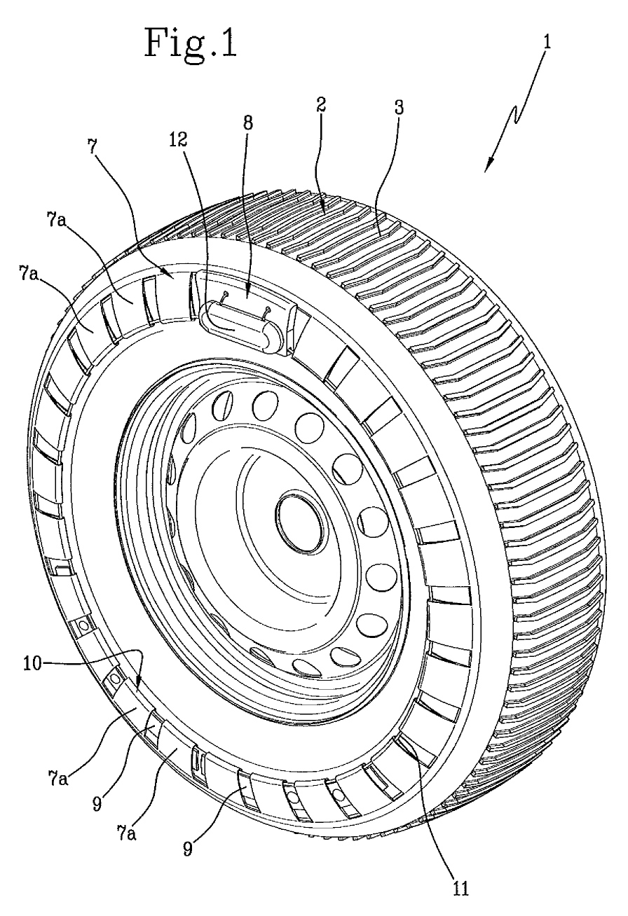

FIG. 2 is a sectional view of an antiskid cover, according to the present invention, fitted onto a tire;

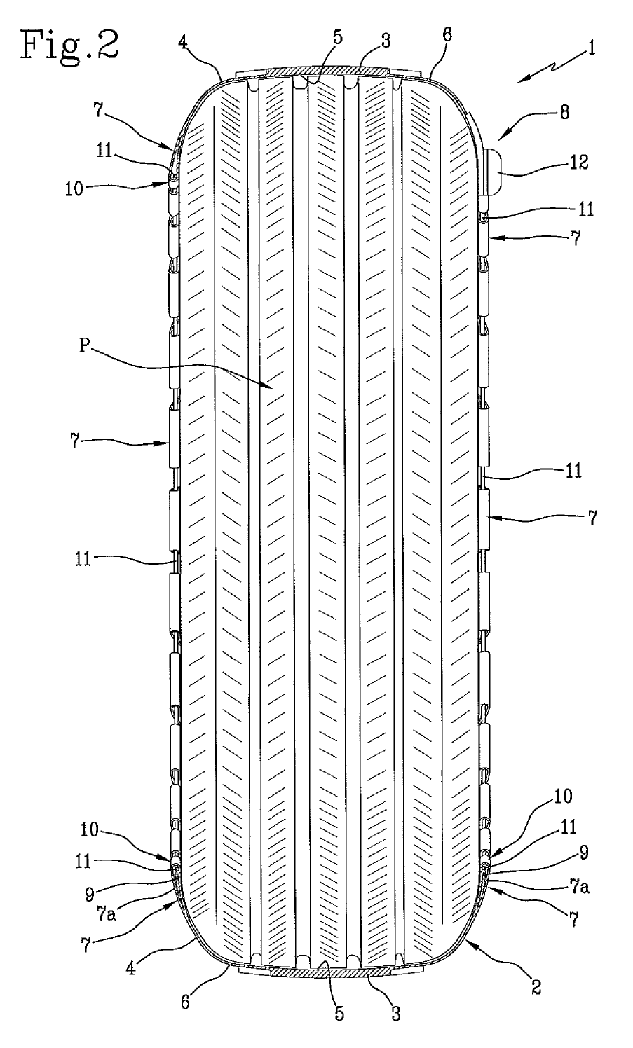

FIG. 3 is a side view of the cover according to the present invention; and

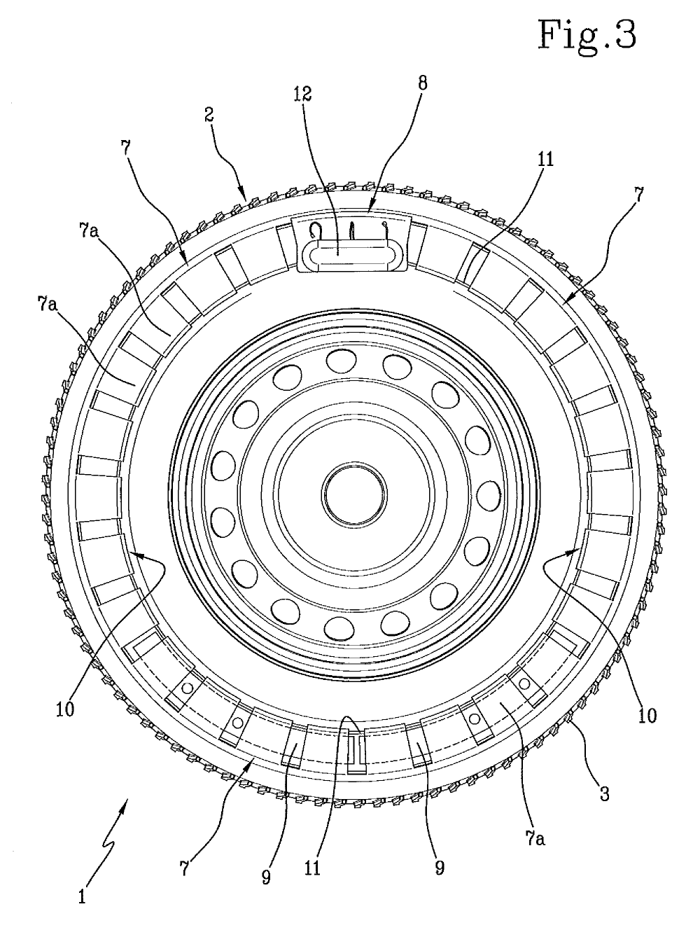

FIG. 4 shows a detail of a device for fixing the cover according to the present invention.

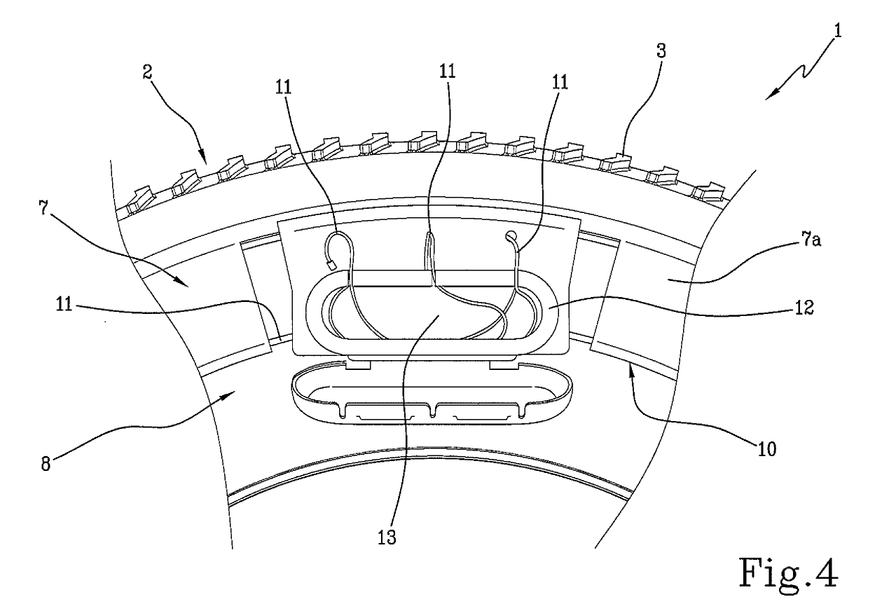

### DETAILED DESCRIPTION OF THE PREFERRED EMBODIMENTS OF THE INVENTION

With reference to the attached figures, an antiskid cover 1 according to the present invention comprises a rigid or elastic support band 2 shaped as a ring and to which a tread 3 of plastic, preferably elastomeric material is applied.

The band 2 exhibits a central portion 4 having an inner surface 5 in contact with the tire P and an outer surface 6 from which the antiskid tread 3 protrudes.

Advantageously, moreover, the inner surface 5 in contact with the tire P comprises a plurality of longitudinal slots.

The longitudinal slots make it possible to adjust the friction, between the cover 1 and tire P, the most correct as possible for a right positioning of cover 1 onto the tire P upon use.

In this context, the adjustment of the friction occurs mostly by increasing or reducing the number of slots so as to increase or reduce the area of contact between the same cover 1 and the tire P.

The slots also allow facilitating the outflow of water, if any, possibly collected between the cover 1 and tire P. The band 2 also comprises two lateral portions 7, joined to the central portion 4 and protruding therefrom, which are intended to cover, at least partially, the sides of tire P. The lateral portions 7 define two circular crowns, each having a ring-shaped cross-section. The lateral portions 7 may be composed of a single annular band or, preferably, of a plurality of annular straps 7a ring-like closed and more or less spaced apart along the whole circumferential development of the band 2. The cover 1 also comprises a device 8, for fixing the cover 1 to the tire P, said device being applied to at least one lateral portion 7. Opposite to the fixing device 8, the cover 1 comprises al least one stiffening element 9.

Preferably, two stiffening elements 9 are present.

Also preferably, the stiffening elements are disposed on both sides of the cover, that is, on the vehicle side (internal) and on the road side (external).

Advantageously, the stiffening elements 9 are located inside the annular straps 7a which form the lateral portions 7, and are attached thereto by fixed retention means such as rivets, for example.

The stiffening element 9 comprises a plate, preferably of arched shape and made of rigid material, for example a metal material, said plate being located a distance away from the fixing device 8.

Sliding within each lateral portion 7 is a closing cable 11 which is connected to the fixing device 8 to correctly and stably positioning the cover 1 onto the tire P.

A storing box 12 is applied on the fixing device 8. In particular, formed inside the box 12 is a seat 13 for receiving closing cables 11 whose flexibility allows them to be held therein.

The fixing device 8, of known type and thus not to be described in greater detail, exhibits a mechanism for interference with the closing cable 11. In particular, the fixing device 8 comprise a first and second plates superimposed to each other, at least the first of which is connected to the band 2. Formed between the two plates is a space inside which two interference elements are housed and between which the closing cable 11 is made to slide and restrain by means, for example, of a plurality of projections fitted directly along the cable 11.

The elements of the fixing device 8, which define the closing mechanism, are lever-movable elements easily accessed and driven manually by a user through operations performed exclusively on the closing cable 11.

Moreover, the fixing device 8 can also be provided on one or both the sides of cover 1.

Once the cover is applied on the tire P, the user pulls the closing cable 11 for tightening the lateral portion 7 around the wheel and makes the cable 11 pass into the fixing device 8 until the same cable becomes blocked therein at the most suitable position, depending on the wheel size and tire P wear (more specifically, at a position which depends on the diameter of rim-and-tire P complex).

The invention achieves major advantages.

The elasticity of the band 2 facilitates the assembly and allows the cover 1 to adhere to the same P more tightly thereby preventing the same tire P from moving sideway on the wheel and being out of center or coming out therefrom.

Moreover, the presence of the stiffening elements 9 ensure a more uniform distribution of the weights along the circumference of the tire P. The stiffening element 9 balances the weight of the fixing device 8: for this reason, it is preferred to locate the stiffening elements 9 spaced apart from the fixing device 8. Moreover, the plates making up the stiffening elements 9 provide edges or barriers which prevent the cover 1 from being moved out of center on the wheel during the normal run. In other words, the plates 9, disposed on both sides of the wheel, form a kind of track which keeps the cover l in centered position on the same wheel.

1. Antiskid cover for tires comprising a ring-shaped band exhibiting an internal surface of contact with the tire (P), an external surface from which an antiskid tread is made to protrude, and two lateral portions defining two circular ring-shaped crowns intended to cover, at least partially, the sides of tire (P); a device for fixing the cover to the tire and applied to at least a lateral portion, each lateral portion having therein at least one stiffening element.

2. Antiskid cover according to claim 1, wherein said at least one stiffening element is disposed at a position opposite to the fixing device.

3. Antiskid cover according to claim 1, wherein it comprises at least two stiffing elements for each lateral portion.

4. Antiskid cover according to claim 1, wherein running inside each lateral portion is a closing cable connected to the fixing device.

5. Antiskid cover according to claim 1, wherein each lateral portion exhibits a plurality of annular straps inside which the stiffening element is inserted.

6. Antiskid cover according to claim 1, wherein said stiffening element is a plate.

7. Antiskid cover according to claim 1, wherein said stiffening element is a plate made of rigid material.

8. Antiskid cover according to claim 1, wherein it further comprises a storage box inside which a seat is formed for receiving closing cables.

9. Antiskid cover according to claim 1, wherein said internal surface of said support band comprises a plurality of longitudinal slots.

10. Antiskid cover according to claim 1, wherein said stiffening element is a plate of arched shape.
